(19) United States
(12) Patent Application Publication
(10) Pub. No.: US 2021/0047145 A1
(43) Pub. Date: Feb. 18, 2021

(54) ELEVATOR

(71) Applicant: Hall Labs LLC, Provo, UT (US)

(72) Inventors: David R. Hall, Provo, UT (US); Andrew Priddis, Mapleton, UT (US)

(73) Assignee: Hall Labs LLC, Provo, UT (US)

(21) Appl. No.: 16/543,431

(22) Filed: Aug. 16, 2019

(51) Int. Cl. B66B 9/00; B66B 11/04; B66B 7/02; B66B 7/04; B66B 15/02; B66B 11/02; B66B 5/18

(52) U.S. Cl. CPC B66B 9/00; B66B 11/043; B66B 7/022; B66B 5/18; B66B 15/02; B66B 11/0226; B66B 7/024; B66B 7/046

(57) ABSTRACT

An elevator is disclosed. The elevator comprises a first upright U-channel guide rail parallel to and opposing a second upright U-channel guide rail. The elevator also comprises a slider with a first side and an opposing second side, wherein a first wheel is attached to the first side and a second wheel is attached to the second side. Some embodiments may comprise additional wheels. The first wheel rolls up and down within the first guide rail, and the second wheel rolls up and down within the second guide rail. A platform extends from the slider. The elevator also comprises a hoist mechanism and a closed loop lifting cable attached to the slider. The hoist mechanism is configured to move the lifting cable and thereby, in cooperation with pulleys, to lift and lower the platform. Preferred embodiments also include a centrifugal brake system and walls and a ceiling on the platform.

### TECHNICAL FIELD

This invention relates generally to the field of elevators.

### BACKGROUND

Elevators have been used for decades for lifting people and objects in both commercial and private contexts. As elevators have become commonplace, they have been increasingly available for use in smaller buildings, such as homes, as well as in large buildings. However, the small space available in smaller buildings has presented some challenges. Most current elevator designs require either a machine room at the top or a pit at the bottom of the elevator shaft with an additional space for a counterweight. Some designs have been adapted for use in homes, but the need for extra space has made them impractical.

### SUMMARY

In a first aspect, the disclosure provides an elevator. The elevator comprises a first upright U-channel guide rail parallel to and opposing a second upright U-channel guide rail. The elevator also comprises a slider with a first side and an opposing second side, wherein a first wheel is attached to the first side and a second wheel is attached to the second side. The first wheel rolls up and down within the first guide rail, and the second wheel rolls up and down within the second guide rail. A platform extends from the slider. The elevator also comprises a hoist mechanism and a closed loop lifting cable attached to the slider. The hoist mechanism is configured to move the lifting cable and thereby, in cooperation with pulleys, to lift and lower the platform. Some embodiments also include additional wheels, a centrifugal brake system, or walls and a ceiling on the platform.

In a second aspect, the disclosure provides an elevator. The elevator comprises a first upright U-channel guide rail parallel to and opposing a second upright U-channel guide rail. The elevator also comprises a slider with a first side and an opposing second side, wherein a first wheel is attached to the first side and a second wheel is attached to the second side. The first wheel rolls up and down within the first guide rail, and the second wheel rolls up and down within the second guide rail. A platform extends from the slider. The elevator also comprises a hoist mechanism, a closed loop lifting cable attached to the slider, and a centrifugal brake system. The hoist mechanism is configured to move the lifting cable and thereby, in cooperation with pulleys, to lift and lower the platform. Some embodiments also include additional wheels or walls and a ceiling on the platform.

In a third aspect, the disclosure provides an elevator. The elevator comprises a first upright U-channel guide rail parallel to and opposing a second upright U-channel guide rail. The elevator also comprises a slider with a first side and an opposing second side, wherein a first wheel and a third wheel are attached to the first side and a second wheel and a fourth wheel are attached to the second side. The first wheel and the third wheel roll up and down within the first guide rail, and the second wheel and the fourth wheel roll up and down within the second guide rail. A platform extends from the slider. The elevator also comprises a hoist mechanism, a centrifugal brake system, and a closed loop lifting cable. The closed loop lifting cable is attached to a top of the slider, runs through the hoist mechanism, around one pulley, down through the slider, around another pulley, and is attached to a bottom side of the slider. The hoist mechanism is configured to move the lifting cable and thereby, in cooperation with pulleys, to lift and lower the platform. Some embodiments also include walls and a ceiling on the platform.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front perspective view of one embodiment of the elevator;

FIG. 2 is a back perspective view of one embodiment of the elevator;

FIG. 3 is a front perspective view of one embodiment of the U-channel guide rails and cross bars with an enlarged view of the guide rails;

FIG. 4 is a perspective view of one embodiment of the slider;

FIG. 5 is a front perspective view of one embodiment of the U-channel guide rails engaged by the slider and platform;

FIG. 6 is a top view of one embodiment of the wheels engaging the U-channel guide rails;

FIG. 7 is an enlarged view of one embodiment of the top of the elevator, depicting the hoist mechanism, lifting cable, brakes, and pulleys;

FIG. 8 is an enlarged view of one embodiment of the bottom of the elevator, depicting, the slider, lifting cable, and pulleys;

FIG. 9 is a schematic view of one embodiment of the attachment of the lifting cable;

FIG. 10 is a back perspective view of one embodiment of the elevator being lifted; and

FIG. 11 is a front perspective view of one embodiment of the elevator being lifted to transport a passenger.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “U-channel” is meant to refer to a usually metal U-shaped rail.

As used herein, “rail” is meant to refer to a bar that forms a track.

As used herein, “slider” is meant to refer to a piece that moves by rolling or sliding.

As used herein, “wheel” is meant to refer to a circular frame or disk that is capable of turning on an axle.

As used herein, “closed loop” is meant to refer to having some or all of the output recirculated and used as the input; without loose ends.

As used herein, “platform” is meant to refer to a usually raised horizontal flat surface.

As used herein, “sheave” is meant to refer to a grooved wheel or pulley.

As used herein, “centrifugal brake system” is meant to refer to a safety mechanism on a hoist, etc. that consists of revolving braking mechanisms that are driven outwards by centrifugal force into contact with a fixed brake drum when the revolving braking mechanisms revolve at excessive speeds.

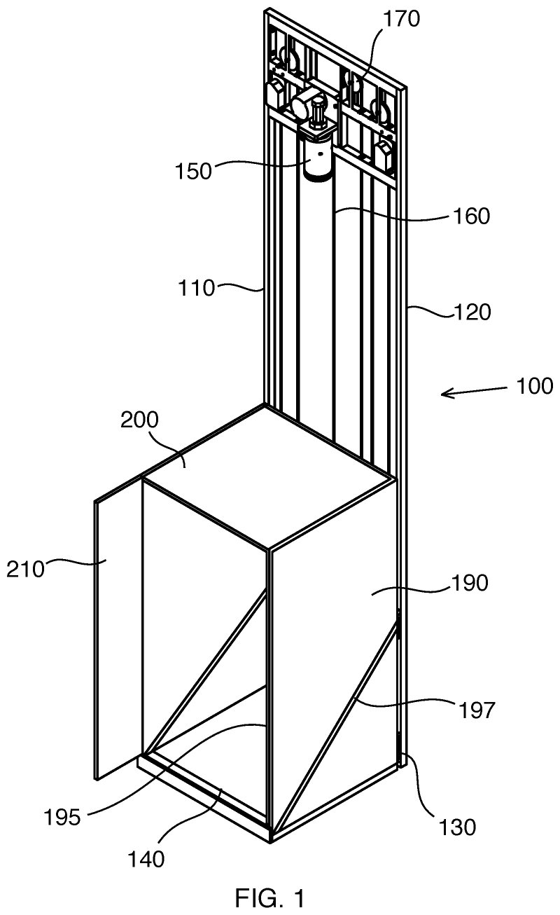

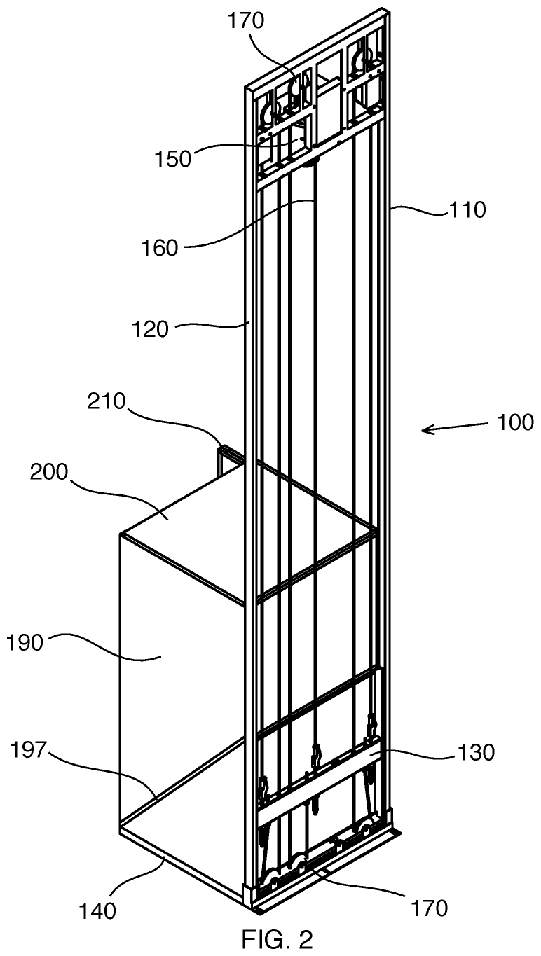

Now referring to the figures, a preferred embodiment of the elevator 100 is depicted. As seen in FIGS. 1 and 2, the elevator 100 comprises a first upright U-channel guide rail 110 parallel to and opposing a second upright U-channel guide rail 120, a slider 130, a platform 140 extending from the slider 130, a hoist mechanism 150, and a closed loop lifting cable 160 attached to the slider 130. The hoist mechanism 150 is configured to move the lifting cable 160 and thereby, in cooperation with pulleys 170, to lift and lower the platform 140.

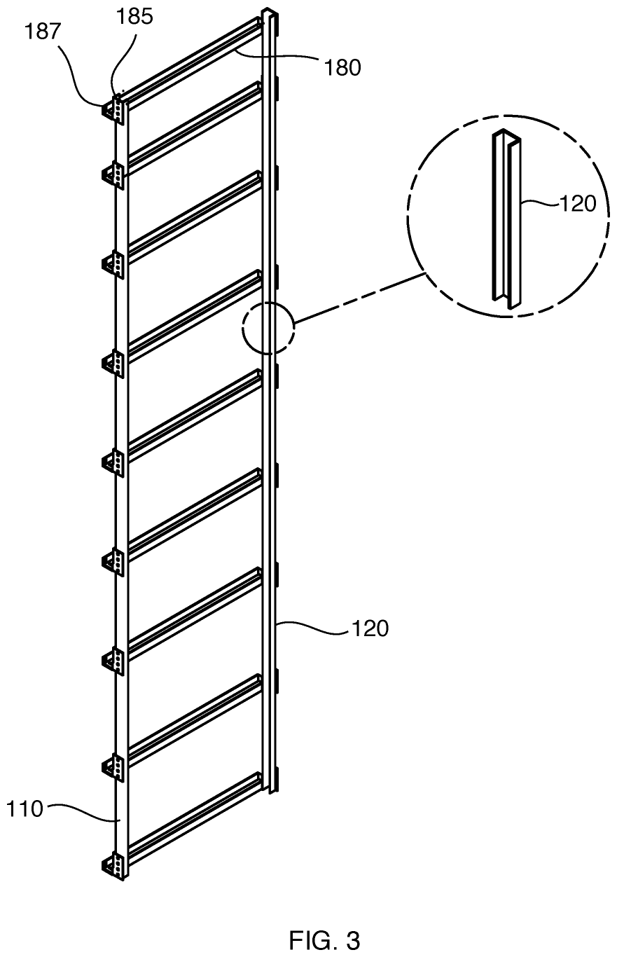

FIG. 3 depicts a preferred embodiment of the U-channel guide rails 110, 120. The guide rails 110, 120 are secured vertically upright and parallel to each other, with open sides of each guide rail 110, 120 facing each other. The U-shape of the guide rails 110, 120 allows the guide rails 110, 120 to act as tracks for wheels.

In the preferred embodiment, the guide rails 110, 120 are spaced approximately four feet apart from outside edge to outside edge. This allows the elevator to be assembled in a shaft four feet by four feet square. In other embodiments, the elevator shaft may be larger or smaller, and the guide rails may be spaced more closely together or more far apart to accommodate the size of the elevator shaft. In still other embodiments, the elevator may be assembled without a shaft, or any enclosed area, such that the distance between the guide rails can be adjusted as desired. Preferably, the guide rails are attached to the elevator shaft wall or another wall by being attached to brackets that are bolted to the wall. In other embodiments, the guide rails may be bolted directly to an elevator shaft wall or another wall that they abut.

In the preferred embodiment, each guide rail 110, 120 is approximately twelve feet in length. The guide rails can be longer or shorter depending on the desired lifting height. Twelve feet is a desirable length for the guide rails if the lifting height is eight feet, or if the distance from one floor to a floor above it in a structure is eight feet. Each guide rail can be one solid piece or several smaller pieces connected together.

In the preferred embodiment, the guide rails 110, 120 are constructed of grade C ASTM A 500 steel, preferably being ready-made steel tubing, which is readily available from local steel suppliers. The steel tubing may be squared, two inches wide by two inches deep, having been formed by bending opposing sides of a flat bar of steel up at ninety degree angles and then bending the edges again at ninety degree angles, so that a square tube is formed with a seam down the middle of one side that is welded shut. To form the guide rails from the steel tubing, the seamed sides of the ready-made tubing may be cut off using a cutting wheel. The cut edges may be ground smooth. The result is a U-shaped, or a U-channel, steel rail, inside of which wheels can travel up and down. Alternatively, the guide rails can be made to order from a steel fabrication company as long as the necessary dimensions are provided. The guide rails can also be made by other means or from other materials, especially other metals.

As depicted in FIG. 3, in the preferred embodiment, one or more cross bars 180 are affixed to the guide rails 110, 120, extending from the first guide rail 110 to the second guide rail 120. Preferably, at least a first cross bar 180 is positioned near the top of the elevator and a second cross bar 180 is positioned near the bottom of the elevator. Additional cross bars 180 may be evenly or unevenly spaced as needed down the lengths of the guide rails to hold the guide rails in place. In the preferred embodiment, there are nine cross bars 180 spaced at approximately equal intervals along the length of the guide rails 110, 120. The cross bars hold the guide rails rigid, vertically upright, and parallel at a set distance apart.

In the preferred embodiment, the cross bars 180 are grade A36 steel angle iron bars. These angle iron bars can be purchased ready made from local steel suppliers. The angle iron bars can be cut to four-foot lengths, so that the guide rails will be spaced four feet apart outside edge to outside edge. In other embodiments, the cross bars may be made from other materials, and they may be longer or shorter.

In the preferred embodiment, the cross bars 180 are attached to the guide rails 110, 120 using gusset plates 185. The gusset plates 185 may be attached using screws, bolts, rivets, welding, or some combination thereof. In the preferred embodiment of this invention, flat head screws are used, so as not to inhibit the free rolling of wheels along the guide rails 110, 120. The gusset plates 185 may also be used to join pieces of the guide rails 110, 120 together, in embodiments where the guide rails 110, 120 are comprised of several shorter pieces.

In the preferred embodiment, in order to account for a potentially uneven wall, neither the guide rails 110, 120 nor the cross bars 180 are bolted directly to a wall. Instead, the cross bars 180 are bolted to L-shaped brackets 187 that are attached directly to an elevator shaft wall or another wall. Preferably, the cross bars 180 are also L-shaped, with holes drilled in one side. Bolts, screws, or another type of connector inserted through the holes are used to join the cross bars 180 to the brackets 187. The cross bars 180 are thereby suspended from the wall by means of the brackets 187, and the guide rails 110, 120, being attached to the cross bars 180, are suspended from the wall as well. The cross bars 180 also hold the guide rails 110, 120 rigid, vertically upright, and parallel at a set distant apart. In other embodiments, the cross bars or guide rails may be bolted directly to an elevator shaft wall or another wall.

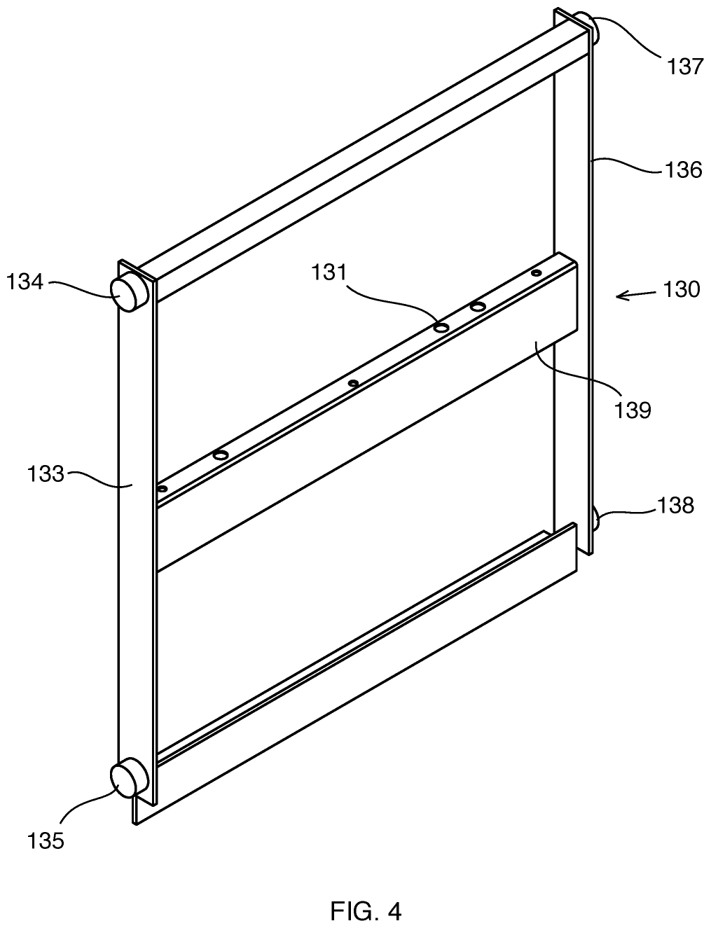

FIG. 4 depicts a preferred embodiment of the slider 130. The slider is a rectangular frame, preferably made of metal and more specifically of steel. The slider moves up and down between the guide rails. On a first vertical side 133 of the slider, a first wheel 134 is attached. A second wheel 137 is also attached to a second vertical side 136 of the slider, which is opposing the first side 133. The first wheel 134 rolls up and down within the first guide rail 110, and the second wheel 137 rolls up and down within the second guide rail 120, such that the slider 130 can move up and down between the guide rails 110, 120.

In the preferred embodiment, a third wheel 135 is also attached to the first side 133 and a fourth wheel 138 is also attached to the second side 136. The third wheel 135 also rolls up and down within the first guide rail 110 and the fourth wheel 138 also rolls up and down within the second guide rail 120. Preferably, the first wheel 134 is attached near the top of the first side 133 and the third wheel 135 is attached near the bottom of the first side 133, but at least two inches from the corners. Likewise, the second wheel 137 is attached near the top of the second side 136, and the fourth wheel 138 is attached near the bottom of the second side 136 at least two inches from the corners.

Having at least two wheels on each vertical side of the slider, especially located near the top and bottom extremities of the vertical sides of the slider, keeps the slider from rotating away from its vertical position, which helps to stabilize the platform that is attached to the slider so that it stays horizontally level. In some embodiments, more than two wheels are attached to each vertical side of the slider.

In the preferred embodiment, the slider 130 is constructed of angle iron bars and rectangular steel bars, welded together into a rectangular frame. Preferably, the height of the slider is approximately equal to or greater than a width of the slider. In the preferred embodiment, the slider is approximately four feet high and three feet eight inches wide and three inches deep. The rectangular frame is reinforced by welding an additional rectangular steel tube 139 midway horizontally inside of the frame. Steel tubing can be procured from local steel distributors and cut to size. Additional bars may be attached horizontally across the frame for additional reinforcement.

The wheels affixed to the upper and lower first and second vertical sides of the slider are heavy duty cam followers. Cam followers are purchased premade from cam follower manufacturers. The preferred embodiment utilizes one- and one-half inch diameter units. To affix a cam follower guide wheel to the slider, a hole is drilled at the specified location on the outside edge of a vertical side of the frame, and the cam follower is inserted and set using a manual press. Care must be taken not to damage the cam follower by hammering it or applying too much torque to the nut. In other embodiments, other types of wheels commonly known to those skilled in the art may be used.

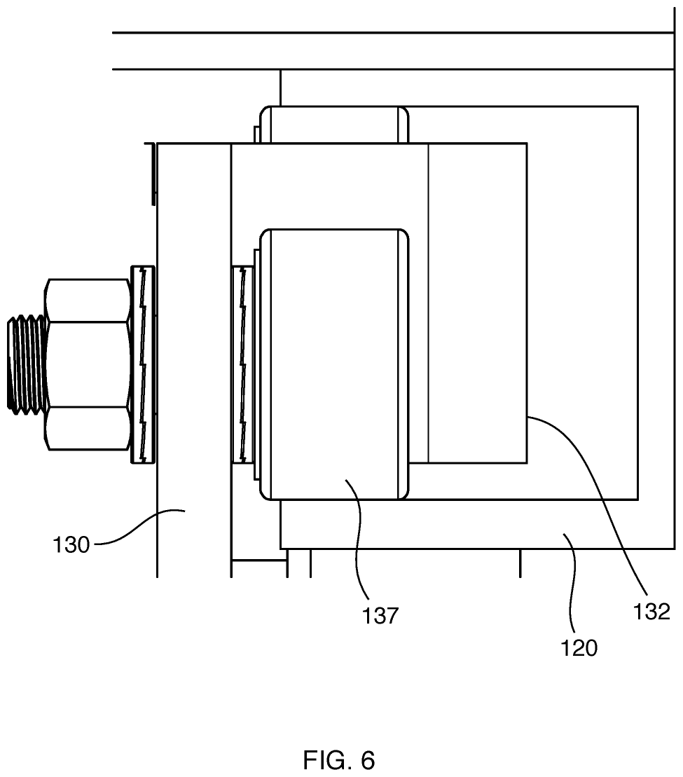

FIG. 6 is a top view of the second wheel 137 of the slider 130 positioned inside the guide rail 120. In the preferred embodiment, elevator guide shoes 132, preferably of plastic, are tucked inside the guide rail 120, around the wheel 137. The elevator guide shoes are similarly tucked around the other wheels in the guide rails. The elevator guide shoes hold the wheels stable inside the guide rails, filling any empty horizontal space, and helping the slider 130 to slide up and down smoothly within the guide rails 110, 120.

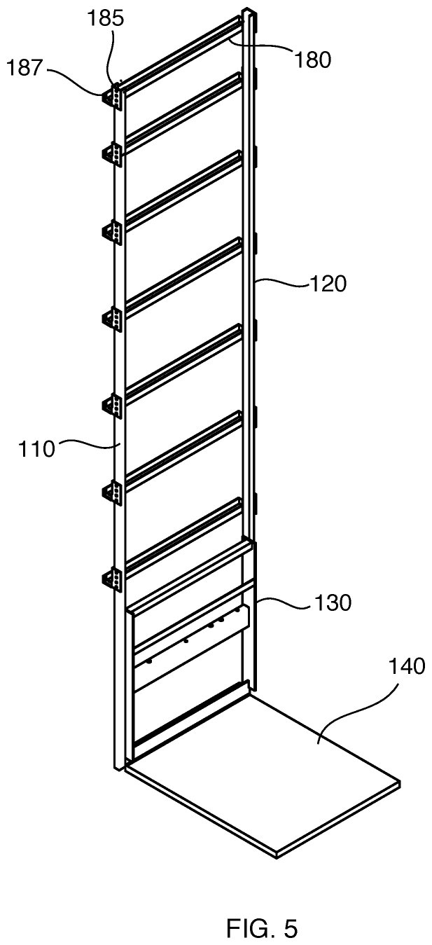

FIG. 5 depicts a preferred embodiment of the slider 130 engaged with the guide rails 110, 120. Wheels attached to vertical sides of the slider 130 are inserted into the U-channel guide rails 110, 120. The wheels roll up and down within the guide rails 110, 120, allowing the slider 130 to slide up and down between the guide rails 110, 120.

As can be seen in FIG. 5, extending from the slider 130 is a platform 140. In the preferred embodiment, the platform 140 comprises a metal rectangular frame with one or more crossbeams spaced at even intervals. The frame is approximately four feet by four feet in size. In other embodiments, it may be larger or smaller. Laid horizontally atop the frame is lightweight metal grating, approximately four feet by four feet in size. Atop the grating, flooring is laid. The flooring can be of any type commonly known in the art, such as wood or plastic or tile.

The platform 140 is attached to the slider 130 such that the platform 140 extends out horizontally from the bottom of the slider 130. The platform 140 may be attached to the slider 130 by means of one or more holes that are drilled into the rectangular metal frame that forms the platform 140 and into the bottom piece of the rectangular frame that forms the slider 130. Bolts, screws, or other connectors may be inserted through the holes and used to attach the platform 140 to the slider 130.

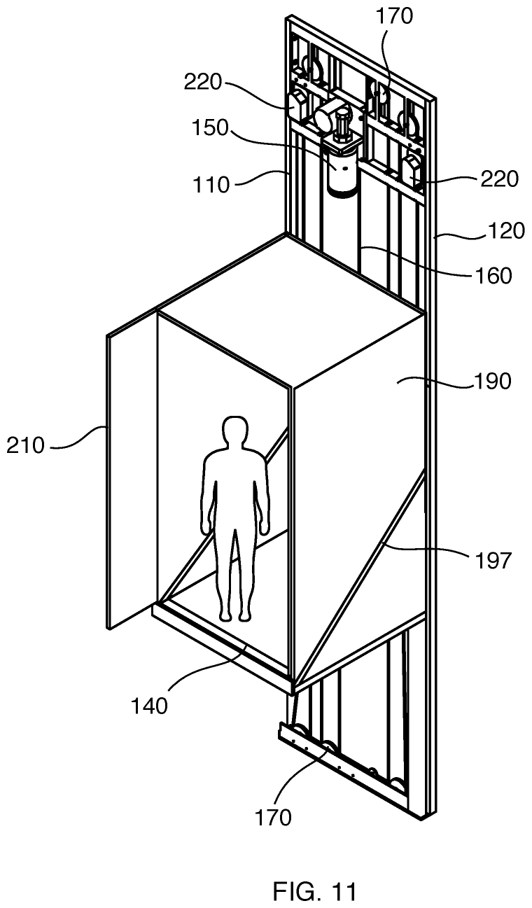

In the preferred embodiment, as can be seen in FIGS. 1-2 and 10-11, one or more walls 190 are attached to the platform 140, and a ceiling 200 is attached to the walls 190. The walls 190 and ceiling 200 are arranged in a box configuration, forming an elevator cab in which persons can ride, as depicted in FIG. 11. Having an elevator cab helps passengers to feel more secure. It also protects them from putting extremities outside the elevator, which can lead to injury.

In the preferred embodiment, the walls 190 are approximately four feet wide and eight feet high, and the ceiling 200 is approximately four feet by four feet. Preferably, the walls 190 and ceiling 200 are composed of extruded polystyrene foam board set in a stainless steel framework 195. This allows the elevator cab to be lightweight. The framework is in the shape of an outline of a box. In other embodiments, the walls and ceiling can be made from other materials, such as lightweight metals, like aluminum, or from wood, glass, plastic, etc.

Preferably, the walls and ceiling are flat packable, such that each component can be dissembled, laid flat, stacked, and shipped, then reassembled in its box configuration. Preferably, each element of the elevator is similarly flat packable so that the elevator can be easily transported, then arranged quickly and easily on site, for example, in a home.

In the preferred embodiment, the ceiling 200 and walls 190 are structural components of the elevator 100. The walls 190 comprise crossbeams 197 that extend from the outermost edges of the platform 140 to the tops of the slider 130, creating right triangles with the platform 140, the crossbeams 197, and the slider 130. The crossbeams 197 help to relieve pressure on the platform 140 when weight is applied, as there are no supports underneath the platform 140. The crossbeams 197 help to stabilize the platform 140 by redistributing the weight to the guide rails 110, 120.

In a preferred embodiment, along with walls 190 and a ceiling 200, the elevator also has a door 210. The door 210 is the size of one wall and replaces one wall. The door 210 may be slid into place when closed, and when it is open, it can be slid alongside an adjoining wall. The door may also be made from extruded polystyrene foam board set in a stainless steel framework. Alternatively, it can be made from a variety of other materials, such as plastic or fabric.

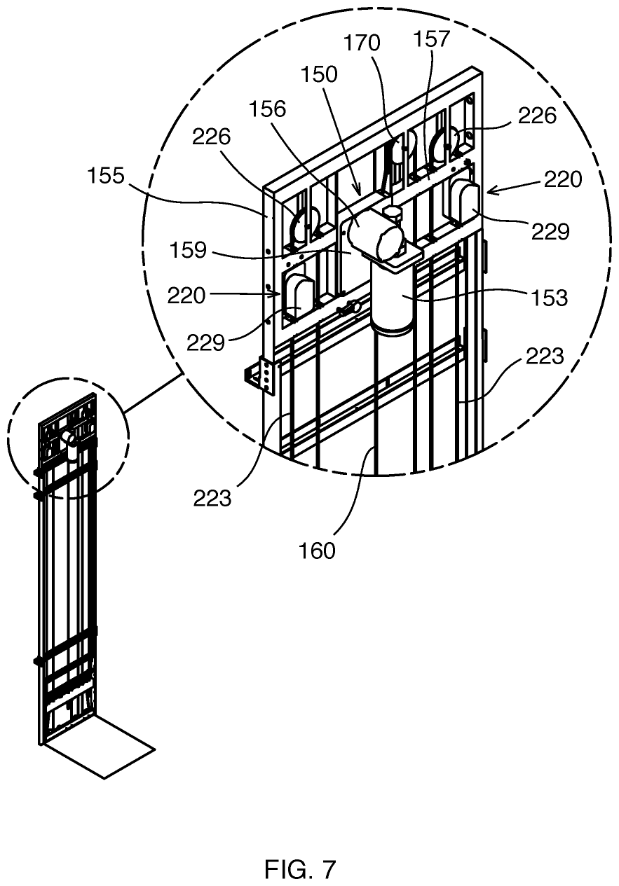

FIG. 7 depicts a preferred embodiment of the hoist mechanism 150. The hoist mechanism 150 is configured to move the lifting cable 160 that is attached to the slider 130, and thereby, in cooperation with pulleys 170, to lift and lower the platform 140. In the preferred embodiment, an LTD60-8P 18 electric man lifting hoist is used for the hoist mechanism, purchased ready-made from Wuxi Rigid machinery Co., Ltd in China. This particular hoist consists of an electric motor 153, a gear box 156, and a rotating grooved wheel or sheave 159 all packaged into one unit. The LTD60-8P 18 is rated to lift 600 kg at a rate of 18 m/min using a 2.2 kw motor and is the preferred unit for this invention. The gear box 156 and sheave 159 in this unit are fabricated from hardened steel for low wear and the motor 153 has a thermal overload protection device. The gear box 156 comprises worm gears, which prevent the lifting cable 160 from slipping backward. Standard components ensure easy access to all wearing parts. In other embodiments, other kinds of hoist mechanisms can be used.

In the preferred embodiment, the hoist mechanism 150 is located near the top of the elevator 100, positioned at or near the top of the guide rails 110, 120. In the preferred embodiment, the hoist mechanism 150 is supported by a hoist mechanism framework 155, which is, preferably, approximately four feet wide and one and a half feet high. The hoist mechanism framework 155 extends up from and is connected to the tops of the guide rails 110, 120 by means of two gusset plates. The hoist mechanism framework 155 comprises a number of steel beams shaped in a rectangle. The beams are at least two inch by two inch square tubing, all grade C ASTM A 500, obtainable from a local steel distributor. There is one horizontal cross beam 157 within the hoist mechanism framework 155, which helps support the hoist mechanism 150. A box for the sheave 159 component of the hoist mechanism 150 rests upon a bottom beam of the hoist mechanism framework 155, and the horizontal cross beam 157 secures its top.

As also depicted in FIG. 7, a closed loop lifting cable 160 runs through the hoist mechanism 150. The lifting cable 160 is attached to the slider 130. The hoist mechanism 150 is configured to move the lifting cable 160 up and down, and thereby to move the slider 130 and the platform 140 that extends from the slider 130 up and down. In the preferred embodiment, the lifting cable 160 enters the bottom of the hoist mechanism 150, winds around the sheave 159, and exits out the top. Since the lifting cable 160 is not connected to the hoist mechanism 150, but only passes through it, the hoist mechanism 150 can be utilized to lift the slider 130 to heights only limited by the height of the guide rails 110, 120.

In the preferred embodiment, the closed loop lifting cable 160 is a ZLP630 Grade 5×19 8.3 MM wire rope procured from Jiangsu Fasten Steel Cord Co., Ltd, which is the largest manufacturer of wire rope in the world. The manufacturer of the hoist mechanism recommends this kind of rope, but other rope or other suppliers can be used. The cable is referred to as a closed loop lifting cable because both ends of the cable are connected to the slider so that the slack, or any of the cable that has already passed through the motor, is recirculated in a continuous loop. There are no loose ends.

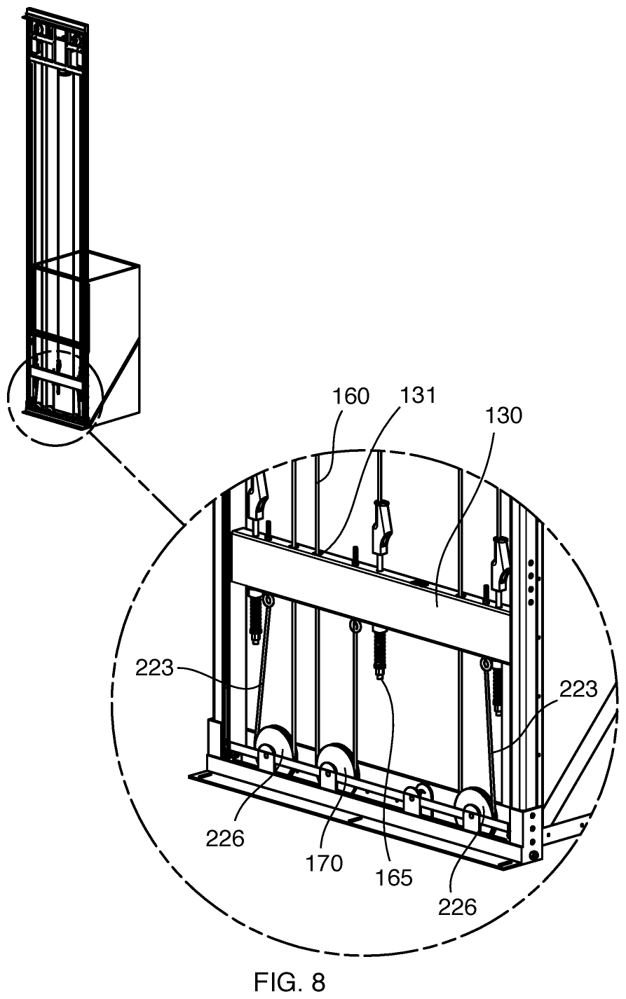

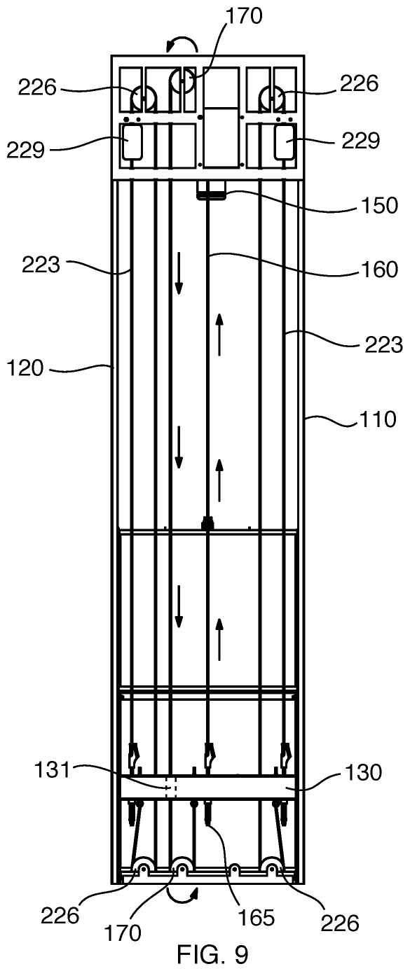

In the preferred embodiment, as depicted in FIG. 9, the lifting cable 160 is attached to the top of the slider 130, then runs upward through the hoist mechanism 150. In order to redirect the lifting cable 160 downward after it passes through the hoist mechanism 150, a pulley 170 is positioned slightly above where the lifting cable 160 exits the hoist mechanism 150, near the top of the elevator 100. The pulley 170 is attached to the hoist mechanism framework 155. Preferably, the pulley 170 is attached to the hoist mechanism framework 155 by means of a nut and bolt. The lifting cable 160 winds around this pulley 170 and back down towards the slider 130. The lifting cable 160 then runs downward through the slider 130, through an opening 131 in the slider 130, which can be seen more clearly in FIGS. 4 and 8. The opening 131 can be formed by drilling a hole in the steel tube that is attached horizontally midway 139 to the slider 130 frame. In order to redirect the lifting cable 160 upward after it passes through the slider 130, another pulley 170 is positioned below the slider 130, near the bottom of the elevator 100. This pulley 170 can also be seen in FIG. 8. The lifting cable 160 winds around the second pulley 170, and back to the slider 130. The lifting cable 160 is then attached to the bottom side of the slider 130.

[59] In the preferred embodiment, the lifting cable 160 is secured to the slider 130 by means of wedge sockets 165, which are bolted directly to the slider 130 frame, one above and one below. Preferably, the wedge sockets 165 are bolted to the steel tube that is attached horizontally midway 139 to the slider 130 frame. A hole is first drilled to facilitate bolting each wedge socket 165 in place. The wedge socket 165 for attaching the lifting cable 160 to the top of the slider 130 should be at the horizontal midpoint of the slider 130.

In the preferred embodiment, the elevator 100 also comprises one or more centrifugal brake systems 220 to protect against failure or slippage of the hoist mechanism 150 or the closed loop lifting cable 160. Each centrifugal brake system 220 comprises a closed loop brake cable 223 attached to the slider 130, brake pulleys 226, and an overspeed safety lock 229. The overspeed safety lock 229 is configured to terminate the lifting cable 160 movement when the movement exceeds a set speed.

Preferably, overspeed safety locks can be obtained from the Wuxi Rigid Machinery Co., Ltd. which is the same company that manufactures the preferred embodiment of the hoist mechanism. In the preferred embodiment, two centrifugal brake systems 220 are provided to ensure adequate safety. Model OSL 308, used in this embodiment, has a rated load of 630 kg, a rated locking speed of 25-30 m/min and a locking distance of L 100 mm. This particular model utilizes an 8.3 mm diameter wire rope, the same as the preferred embodiment of the lifting cable.

The overspeed safety locks 229 are secured, one each side of the hoist mechanism 150, and bolted to the hoist mechanism framework 155. The closed loop brake cables 223 are secured in a closed loop fashion similar to that of the lifting cable 160. Each closed loop brake cable 223 is attached to the top of the slider 130, then runs through an overspeed safety lock, around an upper brake pulley 226, down through the slider 130, and around another lower brake pulley 226. Each closed loop brake cable 223 is then attached to the bottom side of the slider 130. In alternative embodiments, other types of brake systems can be utilized.

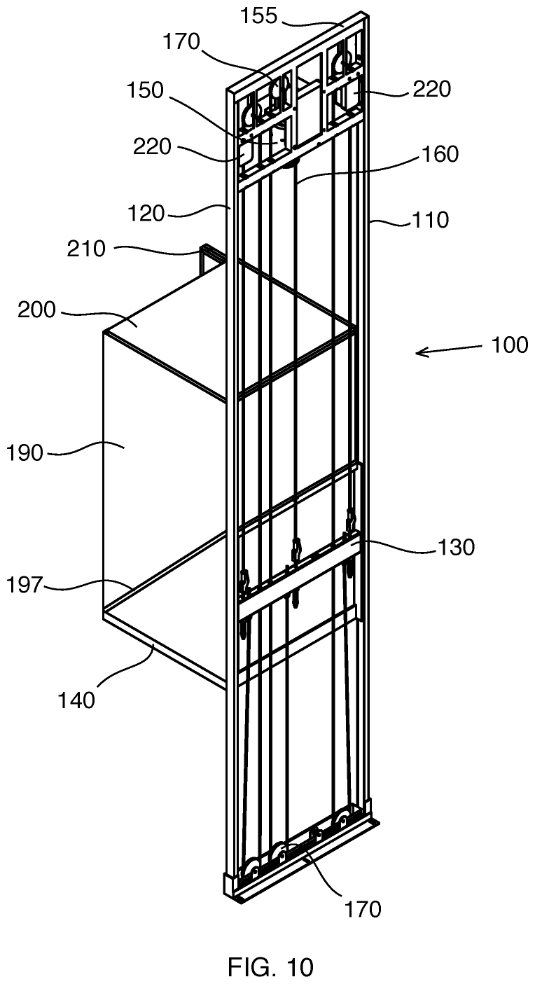

As depicted in FIG. 10, when the motor of the hoist mechanism 150 is engaged, the lifting cable 160 moves through the hoist mechanism 150, moving the slider 130 up or down. As the slider 130 is moved up or down, the platform 140, which includes walls 190 and a ceiling 200 that form an elevator cab in the preferred embodiment, is also moved up and down. In this way, passengers or things located on the platform 140 can be transported to higher or lower positions in elevator fashion, as depicted in FIG. 11.

The invention has been described with reference to various specific and preferred embodiments and techniques. Nevertheless, it is understood that many variations and modifications may be made while remaining within the spirit and scope of the invention.

What is claimed is:

1. An elevator comprising:
a first upright U-channel guide rail parallel to and opposing a second upright U-channel guide rail;
a slider comprising a first side and an opposing second side, wherein a first wheel is attached to the first side and a second wheel is attached to the second side, and wherein the first wheel rolls up and down within the first guide rail, and the second wheel rolls up and down within the second guide rail;
a platform extending from the slider;
a hoist mechanism; and
a closed loop lifting cable attached to the slider;
wherein the hoist mechanism is configured to move the lifting cable and thereby, in cooperation with pulleys, lift and lower the platform.

2. The invention of claim 1, wherein the hoist mechanism is located near a top of the elevator.

3. The invention of claim 1, wherein one pulley is positioned near the top of the elevator and above the hoist mechanism and a second pulley is positioned near a bottom of the elevator.

4. The invention of claim 1, wherein a third wheel is attached to the first side and a fourth wheel is attached to the second side, and wherein the third wheel rolls up and down within the first guide rail, and the fourth wheel rolls up and down within the second guide rail.

5. The invention of claim 1, further comprising walls attached to the platform and a ceiling attached to the walls.

6. The invention of claim 5, wherein the walls and ceiling are composed of extruded polystyrene foam board set in a stainless-steel framework.

7. The invention of claim 1, further comprising one or more cross bars that hold the first guide rail and the second guide rail rigid at a set distance apart.

8. The invention of claim 1, further comprising a hoist mechanism framework that supports the hoist mechanism.

9. The invention of claim 1, further comprising a centrifugal brake system.

10. The invention of claim 9, wherein the brake system comprises a closed loop brake cable attached to the slider, brake pulleys, and an overspeed safety lock, wherein the overspeed safety lock is configured to terminate the lifting cable movement when the movement exceeds a set speed.

11. The invention of claim 1, wherein the hoist mechanism comprises a motor, a gear box, and a rotating sheave.

12. The invention of claim 1, wherein the slider comprises a rectangular metal frame.

13. The invention of claim 12, wherein a height of the slider is approximately equal to or greater than a width of the slider.

14. The invention of claim 1, wherein the elevator is four feet wide or less.

15. The invention of claim 1, wherein an opening in the slider allows the lifting cable to pass through the slider.

16. An elevator comprising:
a first upright U-channel guide rail parallel to and opposing a second upright U-channel guide rail;
a slider comprising a first side and an opposing second side, wherein a first wheel is attached to the first side and a second wheel is attached to the second side, and wherein the first wheel rolls up and down within the first guide rail, and the second wheel rolls up and down within the second guide rail;
a platform extending from the slider;
a hoist mechanism;
a centrifugal brake system; and
a closed loop lifting cable attached to the slider;
wherein the hoist mechanism is configured to move the lifting cable and thereby, in cooperation with pulleys, lift and lower the platform.

17. The invention of claim 16, further comprising one or more cross bars that hold the first guide rail and the second guide rail rigid at a set distance apart, wherein the cross bars are suspended from a wall by brackets.

18. The invention of claim 16, further comprising a hoist mechanism framework that supports the hoist mechanism and the centrifugal brake system.

19. An elevator comprising:
a first upright U-channel guide rail parallel to and opposing a second upright U-channel guide rail;
a slider comprising a first side and an opposing second side, wherein a first wheel and a third wheel are attached to the first side and a second wheel and a fourth wheel are attached to the second side, and wherein the first wheel and third wheel roll up and down within the first guide rail, and the second wheel and fourth wheel roll up and down within the second guide rail;
a platform extending from the slider;
a hoist mechanism;
a centrifugal brake system; and
a closed loop lifting cable attached to a top of the slider, running through the hoist mechanism, around one pulley, down through the slider, around another pulley, and attached to a bottom side of the slider;
wherein the hoist mechanism is configured to move the lifting cable and thereby, in cooperation with pulleys, to lift and lower the platform.

20. The invention of claim 19, wherein an opening in the slider allows the lifting cable to pass through the slider.
